(19) United States
(12) Patent Application Publication
(10) Pub. No.: US 2011/0041669 A1
(43) Pub. Date: Feb. 24, 2011

(54) HOLIDAY ORNAMENT HAVING A ROTATING MECHANISM AND INTERNAL MUSIC-PRODUCING MECHANISM

(75) Inventors: Terry Hermanson, New York, NY (US); Huang Meng-Suen, Kowloon (CN)

Correspondence Address: FITZPATRICK CELLA HARPER & SCINTO, 1290 Avenue of the Americas, NEW YORK, NY, 10104-3800, US

(73) Assignee: Mr. Christmas Incorporated, New York (US)

(21) Appl. No.: 12/545,564

(22) Filed: Aug. 21, 2009

(51) Int. Cl. G10F 1/06; F16H 1/20

(52) U.S. Cl. 84/97; 74/413; 84/94.1

(57) ABSTRACT

An automated ornament includes a power source coupled to a drive shaft that provides rotatory power about a drive axis. The drive shaft is coupled to a first drive gear, which engages a second idler gear such that rotation of the first gear in one direction causes the second gear to rotate in the opposite direction. A third driven gear engages the second gear such that rotation of the second gear in one direction causes the third gear to rotate in the opposite direction. The gear ratio of the first gear to the third gear is at least two to one. When the automated ornament is supported by support means, the power source causes an ornamental housing to rotate about the support means via the first, second, and third gears. The power source also can cause a sound module to produce musical notes via a subsidiary gear train.

### BACKGROUND OF THE INVENTION

1. Field of the Invention

The present invention relates generally to automatic musical instruments and devices. More particularly, the present invention relates to a holiday ornament having a first mechanism for producing musical notes and a second mechanism for causing a portion of the ornament to rotate.

2. Description of Related Art

While the preferred use of this invention is with an ornament, and portions of the following discussion of the invention are made relative to an ornament, the invention is not limited to ornaments. Music boxes, music globes, and the like, are all known types of automated musical instruments or devices, and features of the invention are suitable for application in such instruments and devices. Accordingly, the use of the term ornament is exemplary only, in no way is limiting, and is intended to include other automated musical instruments that might be characterized generally as devices or instruments.

Automated musical instruments, and in particular musical holiday ornaments, are commonly known to be collectibles, heirlooms, conversation pieces, and decorations. Distinctive sounds produced by automated musical instruments often result from reeds, or tines, being vibrated. In particular, in these automated musical instruments, plural tines of varying length and width, each producing a different musical note or sound, are vibrated in a predetermined sequence to create a melody. Conventionally, at least three types of automated musical instruments are known, each of which uses a different method to vibrate the tines, and these types of known automated musical instruments are discussed in U.S. Pat. No. 7,321,090, which is assigned to the assignee of the present application.

In each of the different types of automated musical instruments discussed in the above-identified patent, a rotating member is employed to drive a drum, a disc, or a tape that causes tines to vibrate to produce sounds that are pleasurable for observers to hear. Such automated musical instruments also can employ rotating members for moving ornamental pieces that are pleasurable for observers to view. For example, a music box may include a first rotating member for rotating a drum to vibrate tines that produce sounds, and also may include a second rotating member for moving a figurine in a predetermined pattern.

However, applicants believe that none of those automated musical instruments provides a first rotating member for causing a drum to rotate to vibrate plural tines and a second rotating member for causing an ornamental piece to move, wherein the second rotating member rotates substantially faster than the first rotating member, for example, where the second rotating member rotates twice as fast as the first rotating member.

Accordingly, an improved automated musical instrument is desired that produces musical sounds of conventional automated musical instruments, and also rotates an ornamental piece at a rate sufficient to be perceived readily by an observer and thus add to the aesthetic pleasure that the instrument provides.

### SUMMARY OF THE INVENTION

It is an object of the present invention to provide an automated musical instrument that causes an ornamental piece to rotate quickly, without speeding up a rate of musical note production by the instrument.

It is another object of the present invention to provide an automated musical instrument that can be suspended by a vertical member serving as an axis of rotation for an ornamental housing that rotates at a rate sufficient to be observed readily.

It is yet another object of the present invention to provide an automated musical instrument that can be supported from below by a vertical member serving as an axis of rotation for an ornamental housing that rotates at a rate sufficient to be observed readily.

Accordingly, in one aspect, the present invention is directed to an automated ornament. The automated ornament includes a mounting plate on which a power source is mounted. The power source is coupled to a drive shaft and provides rotatory power about a drive axis.

A first drive gear, a second idler gear, and a third driven gear are rotably mounted with respect to the mounting plate. The drive shaft is coupled to the first gear such that both can rotate about the drive axis. The second gear engages the first gear such that rotation of the first gear in one direction causes the second gear to rotate in the opposite direction. The third gear engages the second gear such that rotation of the second gear in one direction causes the third gear to rotate in the opposite direction. The gear ratio of the first gear to the third gear is least two to one.

An ornamental housing is coupled to the mounting plate. Support means is coupled to the third gear. When the automated ornament is supported by the support means, the mechanical power source causes the ornamental housing to rotate about the support means via the first, second, and third gears.

In another aspect, the present invention is directed to an automated musical ornament. The automated ornament includes a mounting plate on which a power source is mounted. The power source is coupled to a drive shaft and provides rotatory power about a drive axis. The drive shaft is coupled to the power source.

A first drive gear, a second idler gear, a third driven gear, and a subsidiary gear train are rotably mounted with respect to the mounting plate. The drive shaft is coupled to the first gear and serves as an axis of rotation for the first gear. The second gear engages the first gear such that rotation of the first gear in one direction causes the second gear to rotate the opposite direction. The third gear engages the second gear such that rotation of the second gear in one direction causes the third gear to rotate in the opposite direction. The nominal diameter of the first gear is greater than the nominal diameter of the third gear. Music generation means is coupled to the subsidiary gear train such that rotation of the gear train causes the music generation means to produce music.

An ornamental housing is coupled to the mounting plate. Support means is coupled to the third gear. When the automated ornament is supported by the support means, the mechanical power source causes the ornamental housing to rotate about the support means via the first, second, and third gears.

A more complete appreciation along with an understanding of other objects, features, and aspects of the present invention will become apparent from the following detailed description when considered in conjunction with the accompanying drawings.

### BRIEF DESCRIPTION OF THE DRAWINGS

FIG. 1 is a side perspective view of an automated musical ornament according to an embodiment of the present invention.

FIG. 2 is an exploded perspective assembly view of the automated musical ornament shown in FIG. 1.

FIG. 3 is a plan view of a mechanical music module according to an embodiment of the present invention.

FIG. 4 is a bottom plan view of an attaching plate according to an embodiment of the present invention.

FIG. 5 is an enlarged plan view of the mechanical music module according to an embodiment of the present invention with arrows that show directions of movement of the first, second, and third gears when a mechanical power source is being wound.

FIG. 6 is an enlarged top plan view of the mechanical music module shown in FIG. 5 with arrows that show directions of movement of the first and second gears when a power source is providing rotatory power.

### DETAILED DESCRIPTION OF THE INVENTION

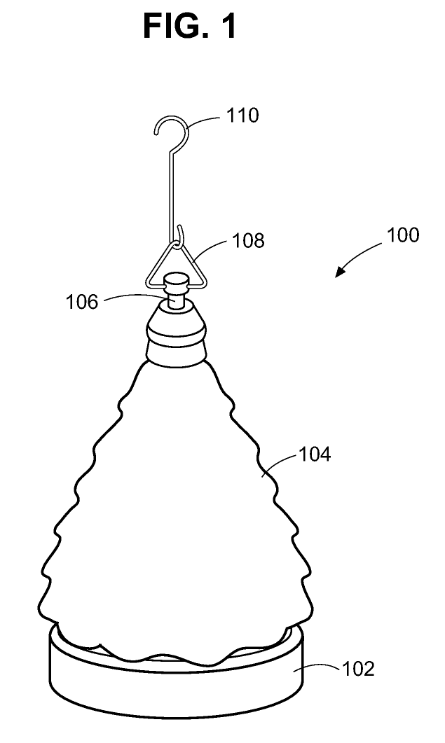

FIG. 1 is a perspective view of an automated musical ornament 100 according to an embodiment of the present invention. The automated musical ornament 100 includes a lower ornamental housing 102, an upper ornamental housing 104, a supporting rod 106, a hanger 108, and a hook 110. The upper ornamental housing 104 in the embodiment shown in FIG. 1 is shaped like a tree. However, the upper ornamental housing 104 could take the shape of any number of a variety of decorative items.

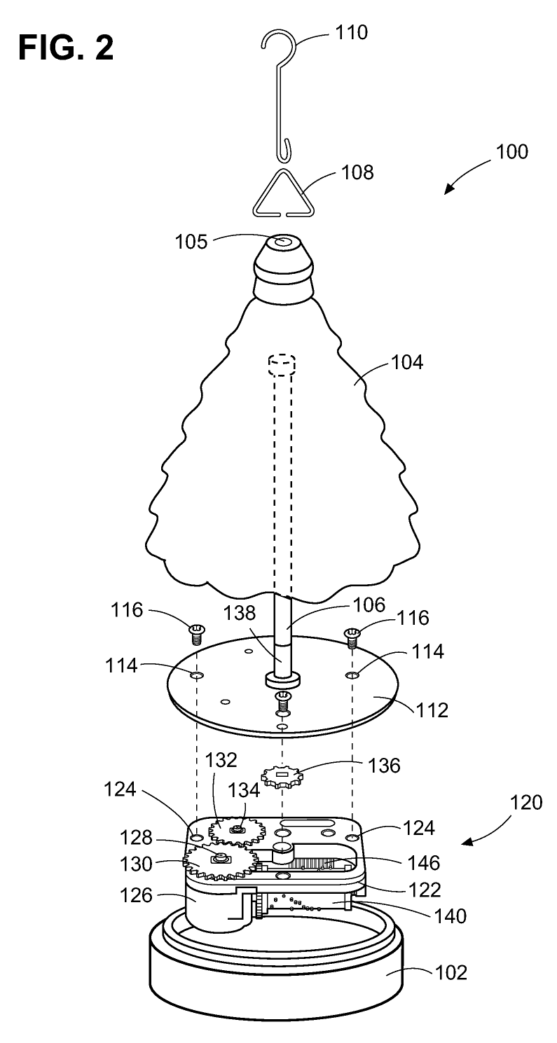

FIG. 2 is an exploded assembly view of the automated musical ornament shown 100 in FIG. 1. As shown in FIG. 2, the automated musical ornament shown 100 also includes an attaching plate 112 and a mechanical sound or music module 120. The attaching plate 112 is used to secure the mechanical music module 120 within the upper ornamental housing 104. The mechanical music module 120 causes the lower ornamental housing 102 and the upper ornamental housing 104 to rotate about the supporting rod 106. In addition, the mechanical music module 120 causes musical notes to be produced.

Initially, assembly of the automated musical ornament 100 is described. A description of the manner in which the mechanical music module 120 causes the ornamental housings 102 and 104 to rotate follows. Finally, the manner in which the mechanical music module 120 causes musical notes to be produced is described.

Assembly of the automated musical ornament 100 is described with reference to FIGS. 1-4. As shown in FIG. 2, a power source 126, a drum assembly 140, and tines 146 are mounted to the lower surface of a mounting plate 122 using conventional techniques. The power source 126 may be coupled to the drum 140 through a series of gears comprising a gear train that causes the drum to rotate. Projections or picks 142 on the surface of the drum assembly 140 may pluck the tines 146 in a particular pattern to produce a musical composition.

The power source 126 can be provided with mechanical or electrical power. More particularly, the power source 126 can be powered by an electrical power source such as, for example, an electrical outlet, an alternating current to direct current converter, a battery, or a solar cell, which is connected to an electric motor that causes a drive shaft 128 to provide rotatory power. Alternatively, the power source 126 can be provided with mechanical power via a wind-up helical or coil spring motor. For example, the coil has a first portion secured to an inner portion of a housing of the power source 126 and an opposing second portion secured to the drive shaft 128 and causes the drive shaft 128 to provide rotatory power as the coil unwinds.

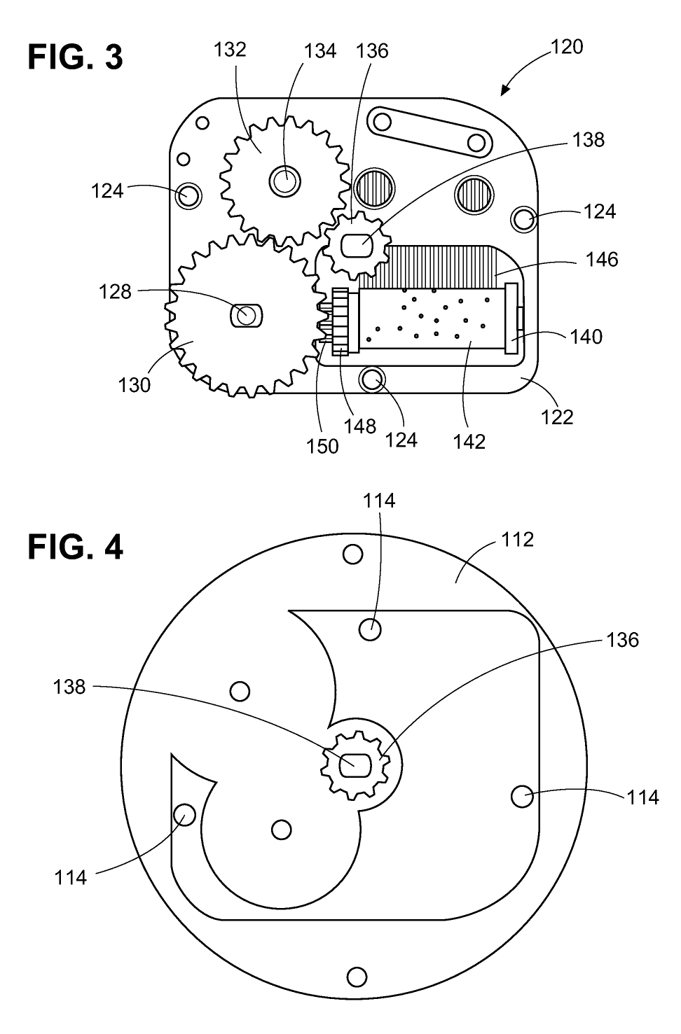

Assembly of the automated musical ornament 100 continues by rotably mounting a first drive gear 130, a second idler gear 132, and a third driven gear 136 to the mounting plate 122. FIG. 3 is a top plan view of the mechanical music module 120 shown in FIG. 2. The mechanical music module 120 includes the mounting plate 122, which has a plurality of apertures 124 formed therethrough.

The drive shaft 128 extends from the power source 126 through an aperture 124 formed in the mounting plate 122 to the upper surface of the mounting plate 122. The first drive gear 130 is mounted on and coupled to an upper portion of the drive shaft 128. As shown in FIG. 3, the first drive gear 130 has an oblong aperture formed through a center portion thereof. The upper portion of the drive shaft 128 has a corresponding shape that fits into the oblong aperture formed through the first drive gear 130. Accordingly, the drive shaft 128 and the first drive gear 130 are keyed together thereby to rotate integrally. That is, rotation of the drive shaft 128 in one direction causes the first drive gear 130 to rotate in the same direction, and similarly rotation of the first drive gear 130 in one direction causes the drive shaft 128 to rotate in the same direction.

The second idler gear 132 is rotably mounted with respect to the upper surface of the mounting plate 122 using a first spacer 134. The lower portion of the first spacer 134 is inserted into an aperture 124 formed through the mounting plate 122. The second idler gear 132 is mounted on the upper portion of the first spacer 134. The first spacer 134 enables the second idler gear 132 to rotate about an axis of rotation that corresponds to a longitudinal axis of the first spacer 134. The first spacer 134 also includes a middle portion disposed between the upper and lower portions thereof. The middle portion of the first spacer 134 ensures that the second idler gear 132 is spaced a predetermined distance from the upper surface of the mounting plate 122, so that it may idle.

Teeth of the first drive gear 130 engage teeth of the second idler gear 132. Rotation of the first drive gear 130 in one direction causes the second idler gear 132 to rotate in the opposite direction. Similarly, rotation of the second idler gear 132 in one direction causes the first drive gear 130 to rotate in the opposite direction.

The third driven gear 136 is rotably mounted with respect to the upper surface of the mounting plate 122 using a second spacer 138. As shown in FIG. 3, a center portion of the third driven gear 136 has an oblong aperture formed therethrough. The lower portion of the second spacer 138 has a corresponding shape that fits into the oblong aperture formed through the third gear 136. As a result, the second spacer 138 and the third driven gear 136 also are keyed to each other thereby to rotate integrally. That is, rotation of the second spacer 138 in one direction causes the third driven gear 136 to rotate in the same direction, and similarly rotation of the third driven gear 136 in one direction causes the second spacer 138 to rotate in the same direction.

The upper portion of the second spacer 138 has threads formed thereon that are inserted through an aperture formed in the center portion of the attaching plate 112. The lower portion of the supporting rod 106 is hollow and has mating threads formed therein. The supporting rod 106 is rotated in the clockwise direction to advance the threads of the supporting rod 106 onto the treads formed on the upper portion of the second spacer 138, thereby coupling the supporting rod 106 to the second spacer 138, as shown in FIG. 2. Therefore, rotation of the supporting rod 106 in the clockwise direction causes the third driven gear 136 to rotate in the clockwise direction.

After the mechanical music module 120 is assembled, the mechanical music module 120 is secured to the attaching plate 112. As indicated in FIG. 2, screws 116 are inserted through apertures 114 formed in the attaching plate 112 and are advanced into corresponding apertures 124 formed in the mounting plate 122 to secure the attaching plate 112 to the mounting plate 112.

When the mounting plate 122 is secured the attaching plate 112, the third driven gear 136 is rotably mounted with respect to the mounting plate 122 and the attaching plate 112. The second spacer 138 includes a middle portion disposed between the upper and lower portions thereof. The middle portion of the second spacer 138 ensures that the third driven gear 136 is spaced a predetermined distance from the upper surface of the mounting plate 122.

Teeth of the second idler gear 132 engage teeth of the third gear 136. Rotation of the second idler gear 132 in one direction causes the third driven gear 136 to rotate in the opposite direction. Similarly, rotation of the third driven gear 136 in one direction causes the second idler gear 132 to rotate in the opposite direction.

After the mechanical music module 120 is secured to the attaching plate 112, an adhesive (e.g., an epoxy resin) is placed on an upper surface of the attaching plate 112. The upper ornamental housing 104 includes one or more mounting portions that extend from an inner surface of the upper ornamental housing 104. The upper ornamental housing 104 is placed above the attaching plate 112 and advanced toward the attaching plate 112 until bottom surfaces of the mounting portions contact the adhesive applied to the upper surface of the attaching plate 112. After the adhesive cures the attaching plate 112 is secured to the upper ornamental housing 104.

When the attaching plate 122 is attached to the ornamental housing 102 in this manner, the upper portion of the supporting rod 106, which has been coupled to the third driven gear 136 via the second spacer 138 as described above, extends through an aperture 105 formed through the upper portion of the upper ornamental housing 104. The upper portion of the supporting rod 106 has a pair of apertures formed therein. The hanger 108 is secured to the supporting rod 106 by inserting opposing end portions of the hanger 108 into the apertures formed in the upper portion of the supporting rod 106. The hook 110 is secured to the hanger 108 in a conventional fashion.

Finally, the lower ornamental housing 102 is attached to the upper ornamental housing 104. For example, an adhesive (e.g., an epoxy resin) is placed on the upper surface of the lower ornamental housing 102. The upper ornamental housing 104 is placed over the lower ornamental housing 102 and advanced until the upper ornamental housing 104 contacts the adhesive on the upper surface of the lower ornamental housing 102. After the adhesive cures, the lower ornamental housing 102 is secured to the upper ornamental housing 104. As noted, the automated musical ornament 100 assembled in the fashion disclosed is shown in FIG. 1.

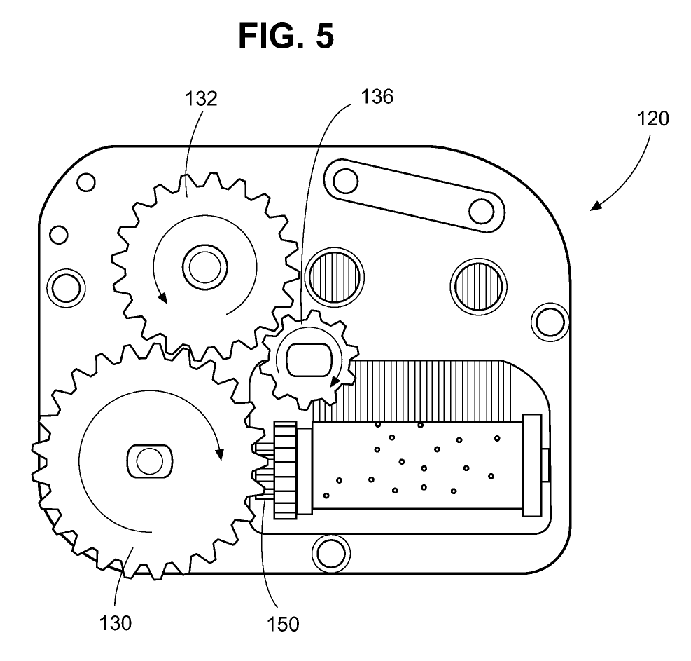

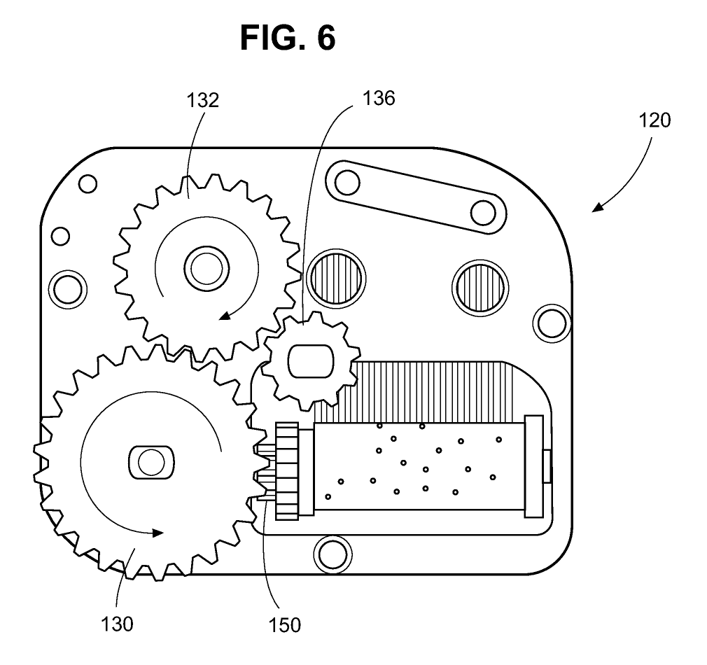

The manner in which the mechanical music module 120 causes the ornamental housings 102 and 104 to rotate is described with reference to FIGS. 5 and 6. The arrows shown in FIG. 5 illustrate the respective directions in which the first drive gear 130, the second idler gear 132, and the third driven gear 136 move when the power source 126 includes a spring motor that is being wound. In this example, the hanger 108 is rotated in the clockwise direction, which causes the supporting rod 106 and the third driven gear 136 to rotate in the clockwise direction. As shown in FIG. 5, clockwise rotation of the third driven gear 136 causes the second gear to rotate in the counter-clockwise direction, which in turn causes the first drive gear 130 to rotate in the clockwise direction. Clockwise rotation of the first drive gear 130 causes the drive shaft 128 to rotate in the clockwise direction, which causes the spring motor to become wound and thereby stores energy. As the spring unwinds to release that energy, the drive shaft is caused to rotate in the counter-clockwise direction, as shown in FIG. 6.

The arrows shown in FIG. 6 illustrate the respective directions in which the first drive gear 130 and the second idler gear 132 move when the automated musical ornament 100 has been suspended from another object via the winding rod 106, the hanger 108, and the hook 110, and when the power source 126 is providing rotatory power. Suspension of the automated musical ornament 100 by the hook 110 prevents the hook 110 from rotating. Because the hook 100 is prevented from rotating, the hanger 108 and the winding rod 106 also are prevented from rotating, which prevents the third driven gear 136 from rotating.

In this example, the power source 126 provides rotatory power in the counter-clockwise direction, which causes the drive shaft 128 and the first gear 132 to rotate and exert a torque in the counter-clockwise direction, as show in FIG. 6. Of course, as noted above, the power source 126 could include an electric motor that causes the drive shaft 128 to provide rotatory power in the counter-clockwise direction.

The torque in counter-clockwise direction exerted by the first drive gear 130 causes the second idler gear 132 to move and exert a torque in the clockwise direction, as shown in FIG. 6. As discussed above, the third driven gear 136 is prevented from rotating while the automated musical ornament 100 is suspended by the suspending rod 106. As a result, the torque in the clockwise direction exerted by the second idler gear 132 on the stationary third driven gear 136 causes the ornamental housings 102 and 104 to rotate about the supporting rod 106 in the clockwise direction. That is, the torque exerted by the power supply 126 via the first drive gear 130 and the second idler gear 132 on the third driven gear 136 causes the ornamental housings 102 and 104 to rotate about the supporting rod 106 in the clockwise direction.

The gear ratio of the first drive gear 130 to the third driven gear 136 determines how fast the third driven gear 136 rotates compared to the first drive gear 130. In a preferred embodiment, the gear ratio of the first drive gear 130 to the third driven gear 136 is 2.5:1. That is, the number of teeth on the first drive gear 130 is two and one-half times the number of teeth on the third driven gear 136. Stated another way, the nominal diameter of the first drive gear 130 is at least two times greater than the nominal diameter of the third driven gear 136, though the gear ratio and ratio of the relative nominal diameters of the respective gears are not precisely the same. In any event, it is believed that a gear ratio of the noted gears of at least 2 to 1 will achieve the objectives of the present invention. As a result of the 2.5:1 gear ratio, for every revolution of the first drive gear 130, the third driven gear 136 revolves two and one-half times.

By selecting the gear ratio to be 2.5:1, the automated musical ornament 100 of the present invention will advantageously operate to rotate the automated musical ornament 100 in a manner that can be perceived more readily and can be more pleasurable for observers to see. The present invention contemplates a gear ratio of the first drive gear 130 to the third driven gear 136 of at least 2.5:1, but higher ratios also may be desirable.

The supply 126 is selected to provide increased torque compared to springs used in conventional automated musical ornaments to ensure that drive shaft 128 produces sufficient torque to rotate the ornamental housings 102 and 104 via the first drive gear 130, the second idler gear 132, and the third gear 136.

The drum assembly 140, however, rotates at the same rate as conventional automated musical ornaments. The automated musical ornament 100, therefore, produces music at the same rate as conventional automated musical ornaments while rotating the ornamental housings 102 and 104 at a faster rate.

Alternate embodiments are contemplated. In some embodiments, the supporting rod 106 may be employed to support the automated musical ornament 100 from below. Instead of the hanger 108, a flat, disc-shaped foot can be attached to the portion of the supporting rod 106 that extends downwardly from the upper ornamental housing 104. Or, for example, the automated musical ornament 100 shown in FIG. 1 can be turned upside down, a flat, disc-shaped foot can be attached the to the portion of the supporting rod 106 extending from the upper ornamental housing 104, and the foot can be placed on the upper surface of a table. Friction between the upper surface of the table and the foot prevent the supporting rod 106 from rotating. As described above, when the power supply 126 delivers rotatory power and the supporting rod 106 is prevented from rotating, a torque is transferred from the drive shaft 128 to the third driven gear 136 via the first and second gears 130 and 132, which causes the ornamental housings 102 and 104 to rotate about the supporting rod 106. In this example, the ornamental housings 102 and 104 rotate in the counter-clockwise direction.

The manner in which the automated musical ornament 100 causes musical notes to be produced is described with reference to FIGS. 2 and 3. As shown in FIG. 3, the left side of the drum assembly 140 includes a gear train that includes gears 148 and 150. A crown gear is mounted on and coupled to the drive shaft 128 below the lower surface of the mounting plate 122. The crown gear and the drive shaft rotate 128 integrally. The crown gear includes teeth that engage teeth the gear 150 of the gear train of the drum assembly 140. By virtue of the crown gear, rotation of the drive shaft 128 causes the drum assembly 140 to rotate. The axis of rotation of the drum assembly 140 and the axis of rotation of the drive shaft 128 are in planes that are perpendicular to each other.

As noted above, a plurality of projections or picks 142 extend radially from the drum assembly 140. As the drum assembly 140 rotates, the projections 142 pluck the tines 146 mounted to the lower surface of the mounting plate 122. Each tine 146 has a different length for producing a different musical note when vibrated by contact with a projection 142 as the drum assembly 140 rotates. By arranging the projections 142 in a predetermined pattern on the drum assembly 140 and causing the drum assembly 140 to rotate at a predetermined rate, the automated musical ornament 100 can produce a sequence of sounds that corresponds to a particular song or melody.

The description provided above shows that the automated musical ornament 100 in accordance with the present invention provides an enhanced visual experience as well as an enhanced listening experience.

While the present invention has been described with respect to what is currently considered to be the preferred embodiments, it is to be understood that the invention is not limited to them. To the contrary, the invention is intended to cover various modifications and equivalent arrangements within the spirit and scope of the appended claims. The scope of the following claims is to be accorded the broadest interpretation so as to encompass all such modifications and equivalent structures and functions.

What is claimed is:

1. An automated ornament, comprising:
a mounting plate;
a power source mounted on said mounting plate and providing rotatory power about a drive axis;
a drive shaft coupled to said power source;
a first gear rotably mounted with respect to said mounting plate, said drive shaft being coupled to said first gear such that both can rotate about said drive axis;
a second gear rotably mounted with respect to said mounting plate, said second gear engaging said first gear such that rotation of said first gear in a first direction causes said second gear to rotate in a second direction opposite the first direction;
a third gear rotably mounted with respect to said mounting plate, said third gear engaging said second gear such that rotation of said second gear in the second direction causes said third gear to rotate in the first direction, wherein the gear ratio of said first gear to said third gear is at least two and to one;
an ornamental housing coupled to said mounting plate;
support means coupled to said third gear, wherein, when said automated ornament is supported by said support means, said power source causes said ornamental housing to rotate about said support means via said first, second, and third gears;
a sound module for producing sound; and
means for coupling said power source to said sound module to cause said sound module to produce sound substantially simultaneously with rotation of said ornamental housing.

2. The automated ornament of claim 1, wherein said power source is a mechanical power source.

3. The automated ornament of claim 2, wherein said power source is a spring motor.

4. The automated ornament of claim 1, wherein said power source is an electric motor.

5. The automated ornament of claim 4, wherein said electric motor is adapted to be supplied with electrical power from one of an electrical outlet, an alternating current to direct current converter, a battery, and a solar cell.

6. The automated ornament of claim 1, wherein a portion of said support means is disposed above the ornamental housing.

7. The automated ornament of claim 1, wherein a portion of said support means is disposed below the ornamental housing.

8. The automated ornament of claim 1, wherein said coupling means comprises a gear train for coupling said power source to said sound module.

9. The automated ornament of claim 8, wherein said sound producing module includes a drum coupled to said gear train to be rotated therethrough.

10. The automated ornament of claim 9, wherein said sound module includes a plurality of tines and said drum includes a plurality of projections extending therefrom, wherein rotation of said drum causes said projections to pluck said tines.

11. The automated ornament of claim 8, wherein said sound module includes a disc rotated through said gear train by said power source.

12. The automated ornament of claim 11, wherein said sound module includes a plurality of tines and said disc includes a plurality of projections extending therefrom, wherein rotation of said disc causes said projections to pluck said tines.

13. The automated ornament of claim 1, wherein a portion of said support means extends through an aperture formed in a center portion of said ornamental housing.

14. An automated musical ornament, comprising:
a mounting plate;
a power source fixedly attached to said mounting plate;
a drive shaft coupled to said power source;
a first gear rotably mounted with respect to said mounting plate, wherein said drive shaft is coupled to said first gear and serves as an axis of rotation for said first gear;
a second gear rotably mounted with respect to said mounting plate, said second gear engaging said first gear, wherein rotation of said first gear in a first direction causes said second gear to rotate in a second direction opposite the first direction;
a third gear rotably mounted with respect to said mounting plate, said third gear engaging said second gear, wherein rotation of said second gear in the second direction causes said third gear to rotate in the first direction, and wherein the nominal diameter of said first gear is at least two times greater than the nominal diameter of said third gear;
a subsidiary gear train mounted with said mounting plate and coupled to said power source also to be driven thereby;
music generation means coupled to said gear train, wherein rotation of said gear train by said power source also causes said music generation means to produce music;
an ornamental housing coupled to said mounting plate; and
support means coupled to said third gear, wherein, when said automated ornament is supported by said support means, said power source causes said ornamental housing to rotate about said support means via said first, second, and third gears substantially simultaneously with production of music by said music generation means.

15. The automated ornament of claim 14, wherein said power source is a mechanical power source.

16. The automated ornament of claim 14, wherein said power source is a spring motor.

17. The automated ornament of claim 14, wherein said power source is an electric motor.

18. The automated ornament of claim 17, wherein said electric motor is adapted to be supplied with electrical power from one of an electrical outlet, an alternating current to direct current converter, a battery, and a solar cell.

19. The automated musical ornament of claim 14, wherein a portion of said support means is disposed above said ornamental housing.

20. The automated musical ornament of claim 14, wherein a portion of said support means is disposed below said ornamental housing.

21. The automated musical ornament of claim 15, wherein said music generation means includes a drum rotated through said gear train.

22. The automated musical ornament of claim 21, wherein said music generation means includes a plurality of tines and said drum includes a plurality of projections extending therefrom, and wherein rotation of said drum causes said projections to pluck said tines.

23. The automated musical ornament of claim 14, wherein said music generation means includes a disc rotated through said gear train.

24. The automated musical ornament of claim 24, wherein said music generation means includes a plurality of tines and said disc includes a plurality of projections extending therefrom, and wherein rotation of said disc causes said projections to contact said tines.

25. The automated musical ornament of claim 14, wherein a portion of said support means extends through an aperture formed in a center portion of said ornamental housing.

26. The automated musical ornament of claim 14, wherein the nominal diameter of said first gear is at least two and one-half times greater than the nominal diameter of said third gear.
